(19) United States
(12) Patent Application Publication
(10) Pub. No.: US 2019/0260156 A1
(43) Pub. Date: Aug. 22, 2019

(54) CONNECTOR

(71) Applicants: AutoNetworks Technologies, Ltd., Mie (JP); Sumitomo Wiring Systems, Ltd., Mie (JP); Sumitomo Electric Industries, Ltd., Osaka (JP)

(72) Inventors: Takehide Terasawa, Mie (JP); Hiromu Ootani, Mie (JP); Takeshi Masuda, Mie (JP); Youjirou Hashimoto, Mie (JP); Kazuo Nakai, Mie (JP)

(21) Appl. No.: 16/344,054

(22) PCT Filed: Jul. 5, 2017
(86) PCT No.: PCT/JP2017/024631

§ 371 Date: Apr. 23, 2019

(30) Foreign Application Priority Data
Oct. 24, 2016 (JP) 2016-207565

(51) Int. Cl. H01R 13/533; H01R 13/52; H01R 13/516

(52) U.S. Cl. CPC H01R 13/533; H01R 2201/26; H01R 13/516; H01R 13/5221

(57) ABSTRACT

A connector 20 includes a terminal 23 connected to terminal end of a wire 22, an inner housing 40 in which the terminal 23 is housed, an outer housing 60 arranged without being in contact with the inner housing 40, and vibration absorbing rubbers 70A and 70B sandwiched between the inner housing 40 and the outer housing 60 when the two housings are fitted to each other. The vibration absorbing rubbers 70A and 70B have a durometer hardness A in a range from 20 to 70.

### TECHNICAL FIELD

The present specification discloses a technique relating to a connector.

### BACKGROUND

Conevnetionally, connectors are known that have a configuration in which a rubber is sandwiched between a plurality of housings. Patent Document 1 discloses a connector that has a configuration in which an elastic part is sandwiched between a terminal-side housing carrier in which a terminal is housed, and a wire-side housing carrier in which an electric wire portion is housed. This connector is designed such that the elastic part elastically deforms to absorb vibration of the wire and damp the vibration on the terminal side.

### PRIOR ART DOCUMENT

### Patent Document

Patent Document 1: JP 2015-018617A

### SUMMARY OF THE INVENTION

### Problems to be Solved

However, even if the vibration of the wire is damped by the elastic part, it is conceivable that the connector may resonate depending on the natural vibration frequency of the connector. If the connector resonates, the terminal housed in the terminal-side housing carrier and a counterpart terminal will slide with respect to each other, causing concern that a defect may occur, such as wear of the terminals.

The technique described in the present specification was made in view of the aforementioned circumstances, and it is an object thereof to provide a connector that can suppress a defect that may be caused by resonance.

### Means to Solve the Problem

According to the present specification, a connector includes: a terminal connected to a terminal end of a wire; a first housing in which the terminal is housed; a second housing arranged without being in contact with the first housing; and a vibration absorbing rubber sandwiched between the first housing and the second housing when the two housings are fitted to each other, wherein the vibration absorbing rubber has a durometer hardness A in a range from 20 to 70.

With this configuration, by setting the durometer hardness A of the vibration absorbing rubber sandwiched between the first housing and the second housing when the two housings are fitted to each other to the range from 20 to 70, it is possible to reduce the amount of displacement of the first housing caused by vibration of the wire, compared to a configuration without a vibration absorbing rubber in which a first housing and a second housing are formed as an integral, or a configuration that employs a vibration absorbing rubber having a durometer hardness A of less than 20 or a durometer hardness A of greater than 70. Accordingly, it is possible to suppress a defect such as wear of a terminal housed in the first housing and a counterpart terminal that may be caused by these terminals sliding with respect to each other when the connector resonates. Thus, this makes it possible to suppress a defect that may be caused by the resonance of the connector.

The following aspects are preferable as embodiments of the technique disclosed in the present specification.

The durometer hardness A of the vibration absorbing rubber may be in a range from 45 to 55.

With this measure, it is possible to further suppress a defect that may be caused by resonance of the connector.

The durometer hardness A of the vibration absorbing rubber may be 50.

With this measure, it is possible to particularly suppress a defect that may be caused by resonance of the connector.

A plurality of vibration absorbing rubbers may be provided, and the plurality of vibration absorbing rubbers may be arranged along the outer periphery of the first housing.

With this measure, it is possible to reduce the manufacturing cost of the vibration absorbing rubbers, compared to a case where a ring-shaped vibration absorbing rubber is used.

The first housing may be an inner housing, and the second housing may be an outer housing arranged outside the inner housing.

The inner housing may have a receiving hole in which the terminal is received, a rubber closure through which the wire is inserted while being in intimate contact with the rubber closure may be provided, the rubber closure closing an opening of the receiving hole, the outer housing may be constituted by a pair of divided members, and the pair of divided members may be provided with holding portions that sandwich and hold the rubber closure.

With this measure, not only can the rubber closure prevent water from entering the receiving hole, but the holding portions of the outer housing sandwiching and holding the wire can suppress transmission of vibration of the wire to the terminal side.

### Effect of the Invention

According to the technique described in the present specification, it is possible to suppress a defect that may be caused by resonance of a connector.

### BRIEF DESCRIPTION OF THE DRAWINGS

FIG. 1 is a longitudinal cross-sectional view illustrating a state in which a connector according to Embodiment 1 is fitted to a male connector.

FIG. 2 is an exploded perspective view of the connector.

FIG. 3 is a perspective view illustrating a state in which one of divided members is removed from the connector.

FIG. 4 is a cross-sectional view of the connector taken along a line A-A in FIG. 1.

FIG. 5 is a cross-sectional view of the connector taken along a line B-B in FIG. 1.

FIG. 6 is a diagram illustrating a configuration of measurement of a displacement caused by the vibration of the connector.

FIG. 7 is a diagram illustrating a relationship between the vibration frequency and the displacement amount relative value, with respect to multiple types of connectors.

FIG. 8 is a diagram illustrating a relationship between the resonance frequency and the displacement amount relative value, with respect to the multiple types of connectors.

FIG. 9 is a cross-sectional view of a connector according to Embodiment 2.

### DETAILED DESCRIPTION TO EXECUTE THE INVENTION

### Embodiment 1

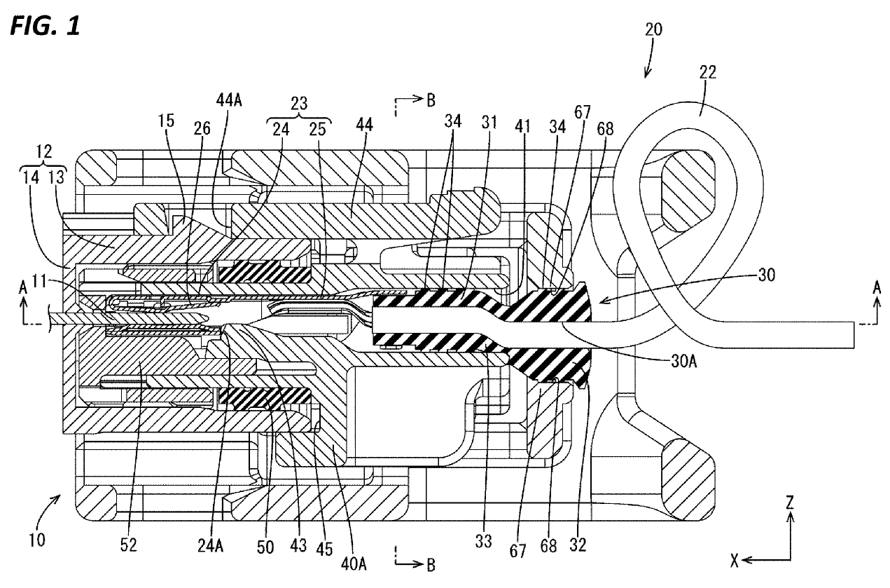

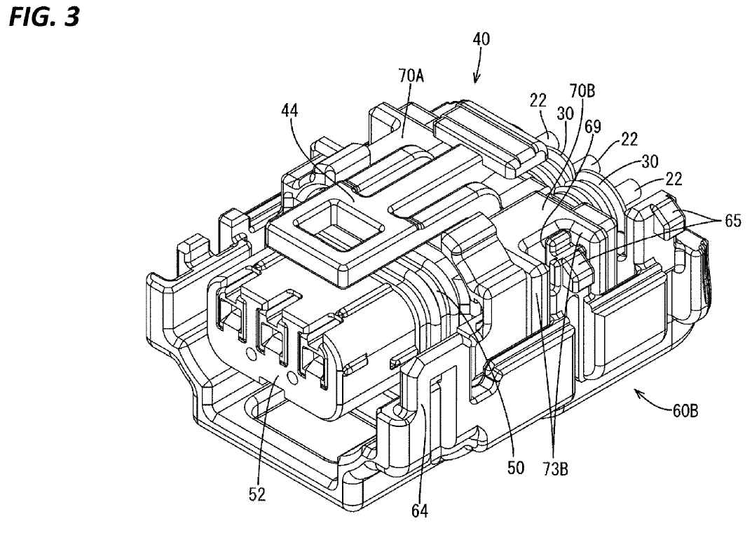

Embodiment 1 will be described with reference to FIGS. 1 to 8.

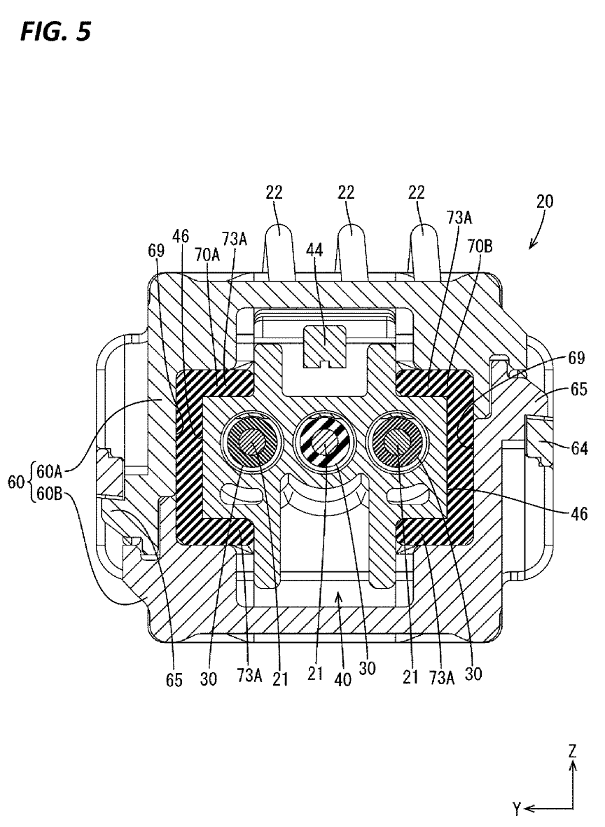

A connector 20 according to the present embodiment can be disposed, for example, on a power supply path of a vehicle such as an electric car or a hybrid car, and is a female connector that can be fitted to a counterpart male connector 10, as shown in FIG. 1. In the following, description will be given assuming that the X direction is “forward”, the Y direction (FIG. 5) is “leftward”, and the Z direction is “upward”.

(Male Connector 10)

The male connector 10 is provided with three rod-shaped or flat plate-shaped male terminals 11, and a male housing 12 made of a synthetic resin in which the three male terminals 11 are housed. The male housing 12 is provided with a hood part 13 that protrudes in the shape of a rectangular tube, and a closing wall part 14 that closes the hood part 13. The hood part 13 has, on the upper surface thereof, a locking protrusion 15 that protrudes upward in a step-like manner.

(Connector 20)

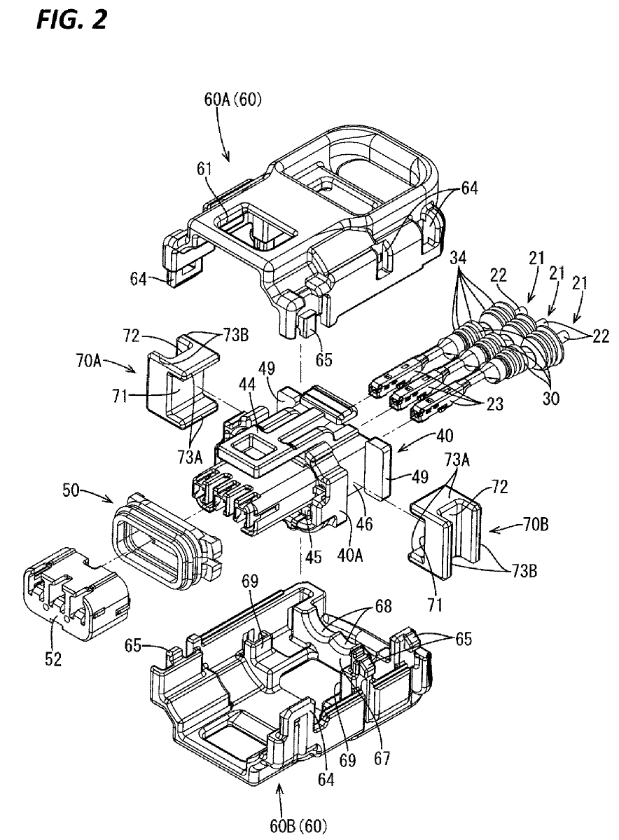

As shown in FIG. 2, the connector 20 is provided with three terminal-equipped wires 21, an inner housing 40 (an example of a “first housing”) in which terminals 23 of the three terminal-equipped wires 21 are housed, an outer housing 60 (an example of a “second housing”) that is arranged outside the inner housing 40 without being in contact with the inner housing 40, and a pair of vibration absorbing rubbers 70A and 70B sandwiched between the inner housing 40 and the outer housing 60.

(Terminal-Equipped Wire 21)

The three terminal-equipped wires 21 are each provided with a wire 22, a female terminal 23 connected to a terminal end of the wire 22, and an elastically deformable rubber closure 30 that is externally fitted to the wire 22. The wire 22 is a covered wire obtained by covering the circumference of a metal conductor with an insulating layer. As shown in FIG. 1, each terminal 23 has a terminal connection portion 24 that is to be connected to the male terminal 11 (counterpart terminal), and a wire connection portion 25 that is connected by clamping to the wire 22. The terminal connection portion 24 is box-shaped, and has, inside thereof, an elastic contact piece 26 that extends rearward from the leading end of the terminal 23 in a folded manner, the elastic contact piece 26 being configured to get into elastic contact with the counterpart male terminal 11.

The rubber closure 30 has the shape of a circular tube with a wire through-hole 30A that is formed in the central portion thereof and is in intimate contact with the outer circumference of the wire 22, and the rubber closure 30 is provided with a sealing portion 31 that closes a receiving hole 41 of the inner housing 40, a held portion 32 that is sandwiched and held by holding portions 67 of the outer housing 60, and a coupling portion 33 that couples the sealing portion 31 with the held portion 32 together as a single body. The sealing portion 31 and the held portion 32 have, on the outer circumferential surfaces thereof, corrugated lip portions 34 lined up in the axial direction of the rubber closure 30.

(Inner Housing 40)

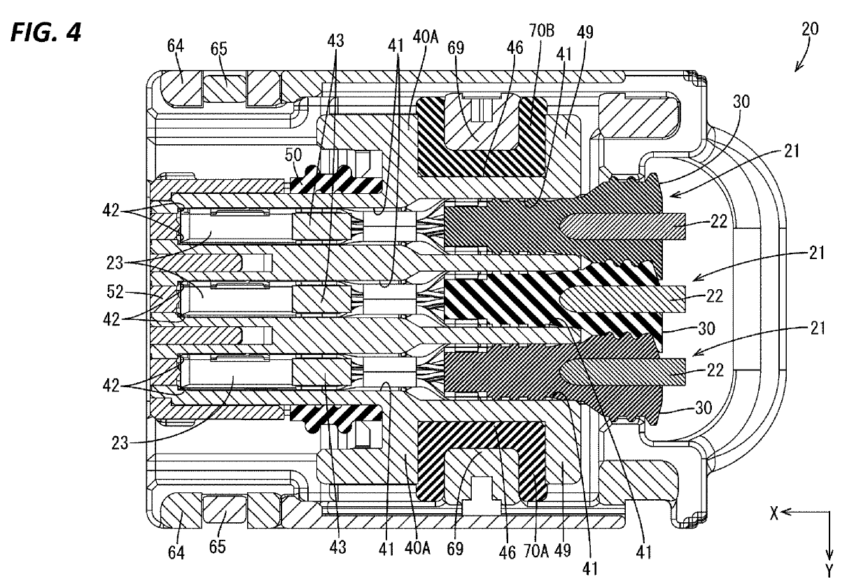

As shown in FIG. 4, the inner housing 40 has three receiving holes 41 into which the terminals 23 are respectively inserted, the three receiving holes 41 being lined up in a left-right direction. Each receiving hole 41 is formed penetrating the inner housing 40 in a front-rear direction, and has, at the front end of the receiving hole 41, a front stopper portion 42 that engages with the leading end of a terminal 23 to restrict forward movement of the terminal 23. The diameter of the front stopper portion 42 is reduced relative to the diameter of the receiving hole 41 in a step-like manner. As shown in FIG. 1, a deflectable/deformable lance 43 extends forward from the inner wall of the receiving hole 41 in a cantilever manner, and engages with a notch 24A of the terminal connection portion 24 to restrict rearward movement of the corresponding terminal 23. On the upper surface of the inner housing 40, a locking arm 44 with a locking hole 44A formed therethrough extends forward, and the hole edge of the locking hole 44A engages with the locking protrusion 15 of the male connector 10 to restrict disengagement of the male connector 10.

As shown in FIG. 2, the inner housing 40 is provided with a flange portion 40A bulging outward in the shape of a flange in substantially intermediate positions in the front-rear direction on the outer circumference of the inner housing 40, and is provided with bulge portions 49 bulging laterally on two side surfaces in the rear end portion of the inner housing 40. Fitting recesses 46 are defined between the flange portion 40A and the bulge portions 49, and the later-described vibration absorbing rubbers 70A and 70B are respectively to be fitted to the fitting recesses 46. A groove portion 45 is formed on the front surface side of the flange portion 40A while extending in a ring shape along the outer periphery of the inner housing 40. As shown in FIG. 1, a seal ring 50 that is in intimate contact with the outer periphery of the inner housing 40, and an end of the hood part 13 of the male housing 12 are inserted into the groove portion 45. A front retainer 52 is fitted to the inner housing 40 from the front side. The front retainer 52 is made of a synthetic resin, and the rear end thereof enters a deflection allowable space for the lance 43 to control deflection and deformation of the lance 43.

(Outer Housing 60)

As shown in FIG. 2, the outer housing 60 is constituted by a pair of divided members 60A and 60B of the same shape, and is shaped such that the entire inner housing 40 is housed inside thereof. Each of the divided members 60A and 60B has a rectangular through hole 61 formed in an intermediate portion on the front end side, and part of the locking arm 44 is exposed from the through hole 61 of the divided member 60A. Each of the divided members 60A and 60B has, on both side walls thereof, frame-shaped engaged portions 63 with a rectangular engaging hole formed therethrough, and the other divided member 60A or 60B has, on the side walls thereof, engaging portions 65 that project and engage with the engaged portions 64. The engaging portions 65 are engaging pieces that are deflectable and deformable, and each have a claw portion that engages with the hole edge of a corresponding engaging hole.

The engaging portions 65 of one of the divided members 60A and 60B engage with the engaged portions 64 of the other divided member to maintain a state in which the pair of divided members 60A and 60B are fitted to each other. The divided members 60A and 60B are provided with, on the inner faces on the rear side thereof, holding portions 67 that sandwich and hold the outer circumference of the held portions 32 of the rubber closures 30. The holding portions 67 stand from the bottom plates of the divided members 60A and 60B, and have, at the leading ends thereof, arc-shaped receiving portions 68 that are fitted to the outer circumferential surface of the rubber closures 30.

(Vibration Absorbing Rubbers 70A and 70B)

The vibration absorbing rubbers 70A and 70B are both elastically deformable, and each include a U-shaped first fitting portion 71 that fits to a fitting recess 46 provided on the outer periphery of the inner housing 40, and a second fitting portion 72 that is provided on the opposite side to the first fitting portion 71, and fits to a protruding portion 69 formed on the inner face of the outer housing 60. The first fitting portion 71 and the second fitting portion 72 respectively have a pair of plate-shaped portions 73A and a pair of plate-shaped portions 73B, the first plate-shaped portions 73A of the first fitting portion 71 extend in directions orthogonal to (directions that intersect with) the second plate-shaped portions 73B of the second fitting portion 72.

Here, the durometer hardness A (shore A hardness, hardness of a type A durometer according to JIS K 6253 standard) of the vibration absorbing rubbers 70A and 70B is set to a range from 20 to 70. More preferably, the durometer hardness A of the vibration absorbing rubbers 70A and 70B is in a range from 45 to 55. Particularly preferably, the durometer hardness A of the vibration absorbing rubbers 70A and 70B is 50. Silicon rubber is used as the vibration absorbing rubbers 70A and 70B of the present embodiment, but the present invention is not limited to this and another type of rubber may also be used. For example, chloroprene rubber, nitrile-butadiene rubber, fluorine-contained rubber, natural rubber, isoprene rubber, butyl rubber, butadiene rubber, or the like may also be used.

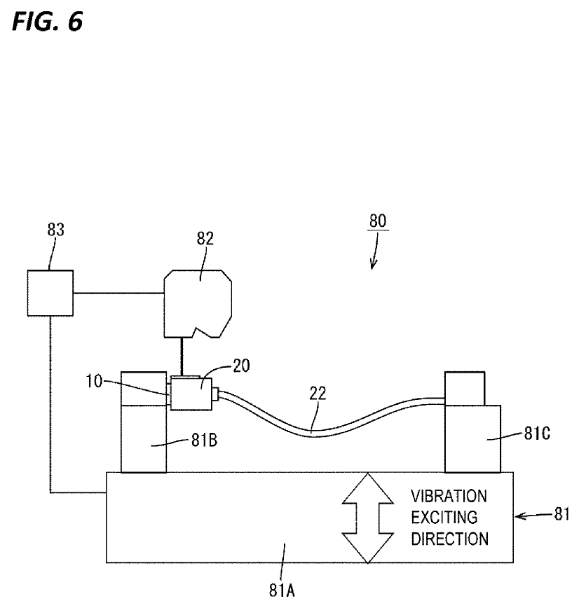

FIG. 6 shows a measuring instrument 80 that measures a displacement of the inner housing 40.

The measuring instrument 80 is provided with a vibration exciter 81, a laser displacement gauge 82 (Keyence Corporation, Type LK-G150), and a control device 83. The vibration exciter 81 includes a base 81A, a first supporting portion 81B that supports the male connector 10 on the base 81A, and a second supporting portion 81C that supports, on the base 81A, one terminal end side of the wire 22. The laser displacement gauge 82 measures a displacement of the inner housing 40 when the vibration exciter 81 is activated.

The control device 83 causes the vibration exciter 81 to excite vibration at a predetermined frequency, and measures a displacement of the inner housing 40 upon receiving a signal corresponding to the displacement given from the laser displacement gauge 82. The connector 20 to which the wire 22 is connected is fitted to the male connector 10 supported by the first supporting portion 81B of the measuring instrument 80.

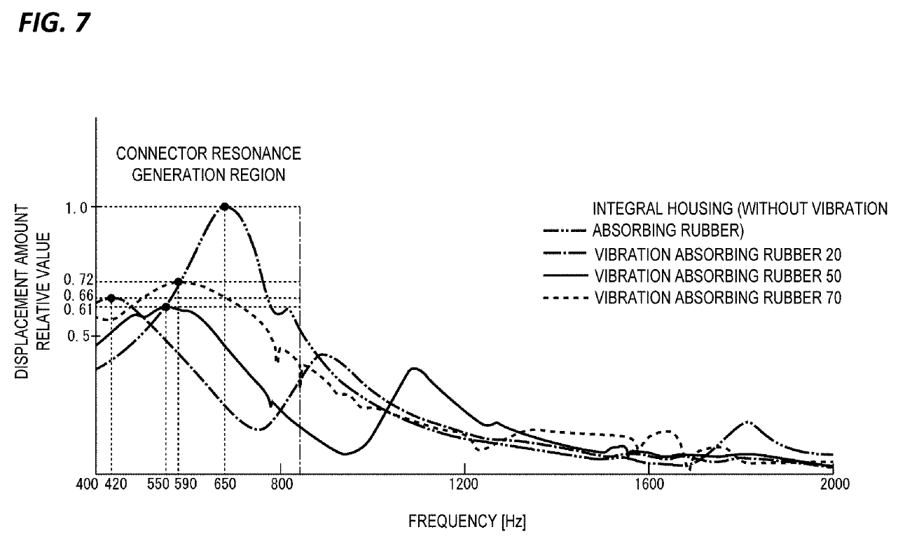

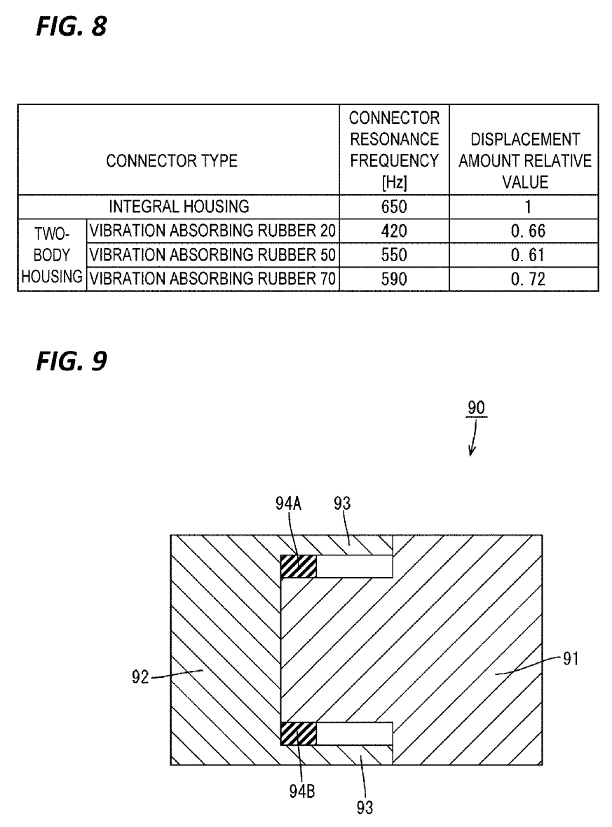

FIGS. 7 and 8 show relationships between the frequency at which the vibration exciter 81 excites vibration and the displacement amount relative value of the inner housing 40, with respect to a connector with an integral housing (one-body (single) housing without the vibration absorbing rubbers 70A and 70B), and connectors 20 (with two-body housing) of the present embodiment whose vibration absorbing rubbers 70A and 70B have the hardness of 20, 50, and 70. Note that “displacement amount relative value” is a ratio of the amount of displacement of the inner housing of a corresponding type of connector to the housing displacement amount of the integral housing. According to the illustrations in FIGS. 7 and 8, generally when the frequency is equal to or less than 850 [Hz], resonance of the connectors is generated and the displacement amounts of the inner housings 40 are large. Of the four different types of connectors, the connector with an integral housing has the largest maximum (displacement amount and) displacement amount relative value of the inner housing 40 when it resonates, and the connectors whose vibration absorbing rubbers 70A and 70B have the hardness of 70, 20, and 50 have the smaller maximum displacement amount relative values in the stated order. In other words, the (displacement amount and) displacement amount relative value of a displacement caused by resonance is smaller as the hardness of the vibration absorbing rubbers 70A and 70B approaches 50, and when the hardness of the vibration absorbing rubbers 70A and 70B is 50, the (displacement amount and) displacement amount relative value of a displacement caused by resonance is the smallest, and thus wear that may be caused by terminals sliding with respect to each other due to vibration of the inner housing 40 is most unlikely to occur.

According to the above-described embodiment, the following functions and effects can be achieved.

The connector 20 includes the terminals 23 connected to terminal ends of the wires 22, the inner housing 40 (first housing) in which the terminals 23 are housed, the outer housing 60 (second housing) arranged without being in contact with the inner housing 40, and the vibration absorbing rubbers 70A and 70B sandwiched between the inner housing 40 and the outer housing 60 (between both of the housings 40 and 60) when the inner housing 40 and the outer housing 60 are fitted to each other, the vibration absorbing rubbers 70A and 70B having a durometer hardness A in a range from 20 to 70.

As a result of the vibration absorbing rubbers 70A and 70B being sandwiched between the inner housing 40 and the outer housing 60 when the two housings are fitted to each other, it is possible to reduce the amount of displacement of the inner housing 40 when the connector 20 resonates, compared to a configuration without vibration absorbing rubbers 70A and 70B in which an inner housing 40 and an outer housing 60 are formed as an integral. Here, according to the present embodiment, by setting the durometer hardness A of the vibration absorbing rubbers 70A and 70B sandwiched between the inner housing 40 and the outer housing 60 to a range from 20 to 70, it is possible to reduce the amount of displacement of the inner housing 40 caused by vibration of the wires 22, compared to a configuration without vibration absorbing rubbers 70A and 70B in which an inner housing and an outer housing are formed as an integral, or a configuration that employs a vibration absorbing rubber having a different durometer hardness A (of less than 20 or greater than 70). Accordingly, it is possible to suppress a defect such as wear of a terminal 23 housed in the inner housing 40 and a counterpart terminal 23 that may be caused by these terminals 23 sliding with respect to each other when, for example, the connector 20 resonates. Thus, this makes it possible to suppress a defect that may be caused by the resonance of the connector 20.

Furthermore, the durometer hardness A of the vibration absorbing rubbers 70A and 70B is in a range from 45 to 55.

With this measure, it is possible to further suppress a defect that may be caused by resonance of the connector 20.

Furthermore, the durometer hardness A of the vibration absorbing rubbers 70A and 70B is 50.

With this measure, it is possible to particularly suppress a defect that may be caused by resonance of the connector 20.

Furthermore, the plurality of vibration absorbing rubbers 70A and 70B are provided, and the plurality of vibration absorbing rubber 70A and 70B are arranged along the outer periphery of the inner housing 40.

With this measure, it is possible to reduce the manufacturing cost of the vibration absorbing rubbers 70A and 70B, compared to a case where a ring-shaped vibration absorbing rubber 70A, 70B is used.

Furthermore, the inner housing 40 has the receiving holes 41 in which the terminals 23 are inserted, the rubber closures 30 through which the wires 22 are respectively inserted while being in intimate contact with the rubber closures 30, each rubber closure 30 closing the opening of a receiving hole 41, and the outer housing 60 is constituted by the pair of divided members 60A and 60B, and the pair of divided members 60A and 60B are provided with the holding portions 67 that sandwich and hold the rubber closures 30.

With this measure, not only can the rubber closures 30 prevent water from entering the receiving holes 41, but the holding portions 67 of the outer housing 60 sandwiching and holding the wires 22 can suppress transmission of vibration of the wires 22 to the terminal 23 side.

### Embodiment 2

As shown in FIG. 9, a connector 90 according to Embodiment 2 has a configuration in which vibration absorbing rubbers 94A and 94B are arranged between a male housing 91 (an example of a “first housing”) and a female housing 92 (an example of a “second housing”). In the following, description of the same configuration as that of Embodiment 1 is omitted.

The terminal 23 of a terminal-equipped wire 21 (omitted in FIG. 9) is housed in the male housing 91. A terminal (not shown) is housed in the female housing 92. The pair of vibration absorbing rubbers 94A and 94B are sandwiched in gaps between the outer periphery of the leading end of the male housing 91 and the inner periphery of the hood part 93 of the female housing 92. The vibration absorbing rubbers 94A and 94B have the shape of, for example, a rectangular parallelepiped, and have the durometer hardness A in a range from 20 to 70, and particularly preferably have the durometer hardness A of 50.

According to the configuration of Embodiment 2, since a displacement can be suppressed that may be caused by resonance of the connector 90, it is possible to suppress wear or the like that may be caused by terminals sliding with respect to each other due to vibration of a wire 22 connected to one of the male housing 91 and the female housing 92, making it possible to suppress a defect that may be caused by the resonance of the connector 90.

### Other Embodiments

The technique described in the present specification is not limited to the embodiments explained with reference to the above description and the drawings, and the technical scope of the technique encompasses, for example, the following embodiments.

(1) The connector 20 in Embodiment 1 is assumed to be a female connector, but may be a male connector.

(2) The positions and the number of the vibration absorbing rubbers 70A, 70B, 94A, and 94B are not limited to those in the configuration of the above-described embodiments. For example, one or at least three vibration absorbing rubbers may also be used.

(3) The number of the terminal-equipped wires 21 is not limited to that in the above-described embodiments, and may also be a different number.

### LIST OF REFERENCE NUMERALS

10: Male connector

20: Connector

21: Terminal-equipped wire

22: Wire

23: Terminal

30: Rubber closure

30A: Wire through-hole

40: Inner housing (first housing)

41: Receiving hole

60: Outer housing (second housing)

60A, 60B: Divided members

67: Holding portion

70A, 70B, 94A, 94B: Vibration absorbing rubber

90: Connector

91: Male housing (first housing)

92: Female housing (second housing)

1. A connector comprising:
a terminal connected to a terminal end of a wire;
an inner housing in which the terminal is housed, and that has fitting recesses on an outer periphery thereof;
an outer housing arranged outside the inner housing without being in contact with the inner housing, the outer housing having protruding portions on an inner face thereof; and
a plurality of vibration absorbing rubbers that are arranged along the outer periphery of the inner housing, and are sandwiched between the outer periphery of the inner housing and the inner face of the outer housing when the inner housing and the outer housing are fitted to each other,
wherein each of the plurality of vibration absorbing rubbers has a first fitting portion that fits to one of the fitting recesses, and a second fitting portion that is provided on a side opposite to the first fitting portion, and fits to one of the protruding portions, and
the vibration absorbing rubber has a durometer hardness A in a range from 20 to 70.

2. The connector according to claim 1,
wherein the durometer hardness A of the vibration absorbing rubber is in a range from 45 to 55.

3. The connector according to claim 1,
wherein the durometer hardness A of the vibration absorbing rubber is 50.

4. A connector comprising:
a terminal connected to a terminal end of a wire;
an inner housing that has a receiving hole in which the terminal is received;
an outer housing arranged outside the inner housing without being in contact with the inner housing;
a vibration absorbing rubber sandwiched between the inner housing and the outer housing when the two housings are fitted to each other; and
a rubber closure through which the wire is inserted while being in intimate contact with the rubber closure, and that closes an opening of the receiving hole,
wherein the inner housing has a receiving hole in which the terminal is received,
the outer housing is constituted by a pair of divided members,
the pair of divided members are provided with holding portions that sandwich and hold the rubber closure, and
the vibration absorbing rubber has a durometer hardness A in a range from 20 to 70.

5. The connector according to claim 4,
wherein a plurality of vibration absorbing rubbers are provided, and the plurality of vibration absorbing rubbers are arranged along the outer periphery of the inner housing.

6. (canceled)
